(19) United States
(12) Patent Application Publication
(10) Pub. No.: US 2018/0118341 A1
(43) Pub. Date: May 3, 2018

(54) UNMANNED FLYING SPRAY SYSTEM

(71) Applicant: National Changhua University of Education, Changhua City (TW)

(72) Inventor: Chung-Chi LIN, Changhua City (TW)

(21) Appl. No.: 15/797,879

(22) Filed: Oct. 30, 2017

(30) Foreign Application Priority Data
Nov. 1, 2016 (TW) 105135392

(51) Int. Cl. B64D 1/18; B64C 13/22; B64C 39/02; A01M 7/00

(52) U.S. Cl. CPC B64D 1/18; B64C 13/22; B64C 2201/027; A01M 7/0003; B64C 2201/128; B64C 39/024

(57) ABSTRACT

An unmanned flying spray system includes a flying device, an air valve, and a spraying device. The flying device is provided with a controller including a control module and a power supply module electrically connected to the control module for supplying power to the flying device. The air valve is disposed on the flying device and connected with a gas cylinder for outputting a gas power. The spraying device includes a pesticide container, an electromagnetic control valve electrically connected with the control module, and a nozzle. The pesticide container has a diverting member connected with the air valve, the pesticide container, and the nozzle. The electromagnetic valve is disposed between the diverting member and the nozzle. The unmanned flying spray system sprays a liquid by use of gas power, so as to significantly reduce the overall weight and improve the stability of flying.

### BACKGROUND OF THE INVENTION

### 1. Field of the Invention

The present invention relates to flying spray systems, and more particularly, to an unmanned flying spray system, which spays pesticide through a nozzle by use of gas power.

### 2. Description of the Related Art

In the traditional method of pest control, a farmer usually carries a barrel-shaped pesticide container for manually spraying the pesticide by use of a sprayer. Farmer usually wears a mask during the pesticide sprayer process. However, small gaps still exist upon the mask, causing the farmer to inhale a certain amount of pesticide during the spraying process. As a result, body organs might degenerate in a long period.

For resolving the issues above, industry has combined the recently populated flying device with the spraying device into a flying spray device. Most of the flying spray device nowadays needs to be equipped with additional motor for providing power, so as to trigger the spraying device to spray pesticide.

CN205427597U discloses a pesticide sprinkling system, including an unmanned helicopter platform, an autonomous flight control device, and a pesticide spraying means, wherein the pesticide spraying means includes a pump and a pesticide container that are connected and driven by a controller to spray the pesticide. However, such equipment are easily overweight, causing an instability during the remote-controlled flying operation, such that the pesticide is unevenly sprayed.

### SUMMARY OF THE INVENTION

For improving the flying instability issue of a known unmanned flying spraying system above, an embodiment of the present invention discloses an unmanned flying spray system, which sprays pesticide by use of gas power, wherein the weight of the flying device is reduced, so as to improve the flying stability of the flying device.

For achieving the aforementioned objectives, an unmanned flying spray system in accordance with an embodiment of the present invention is provided, comprising:
a flying device provided with a controller, the controller including a control module and a power supply module electrically connected with the control module, the power supply module providing a flying power to the flying device;
an air valve disposed on the flying device, the air valve connected with a gas cylinder, the gas cylinder outputting a gas power; and
a spraying device provided with a pesticide container, an electromagnetic control valve electrically connected with the control module, and a nozzle, the pesticide container provided with a diverting member, the diverting member connected with the air valve, the pesticide container, and the nozzle, wherein the electromagnetic control valve is disposed between the diverting member and the nozzle.

With such configuration, the present invention applies gas power for spraying pesticide, and the overall weight of the flying device is greatly reduced. Therefore, the flying stability is improved, and the pesticide containing capability is increased, so as to reduce the refilling demand of the pesticide.

### BRIEF DESCRIPTION OF THE DRAWINGS

FIG. 1 is a perspective view of the unmanned flying spray system in accordance with an embodiment of the present invention.

FIG. 2 is a front view of the unmanned flying spray system in accordance with an embodiment of the present invention.

FIG. 3 is a partially enlarged view of FIG. 2.

FIG. 4 is a right side view of the unmanned flying spray system in accordance with an embodiment of the present invention.

FIG. 5 is a partially enlarged view of FIG. 4.

FIG. 6 is a block diagram illustrating the flying device being controlled by the controller to fly.

FIG. 7 is a flow diagram illustrating the operation process of gas power in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

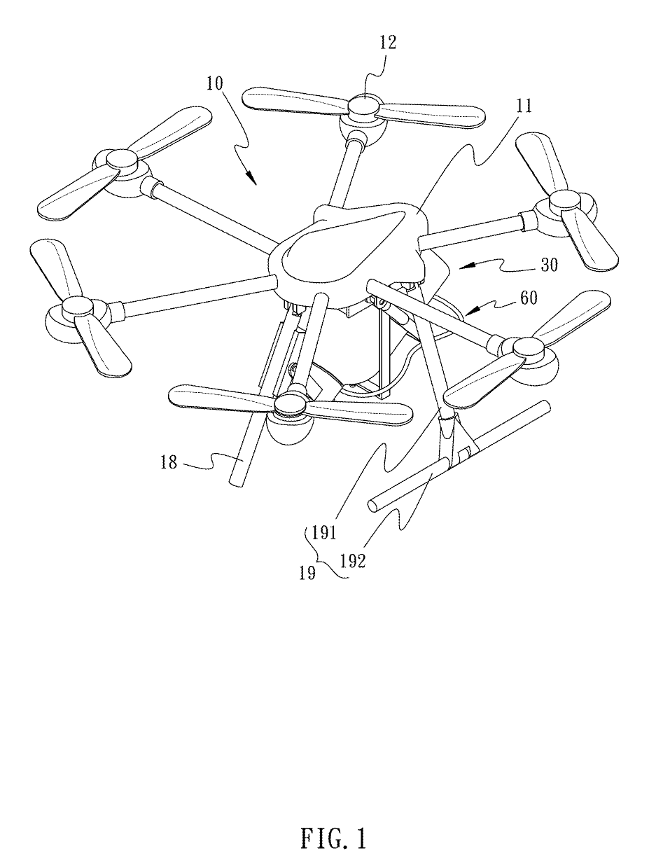

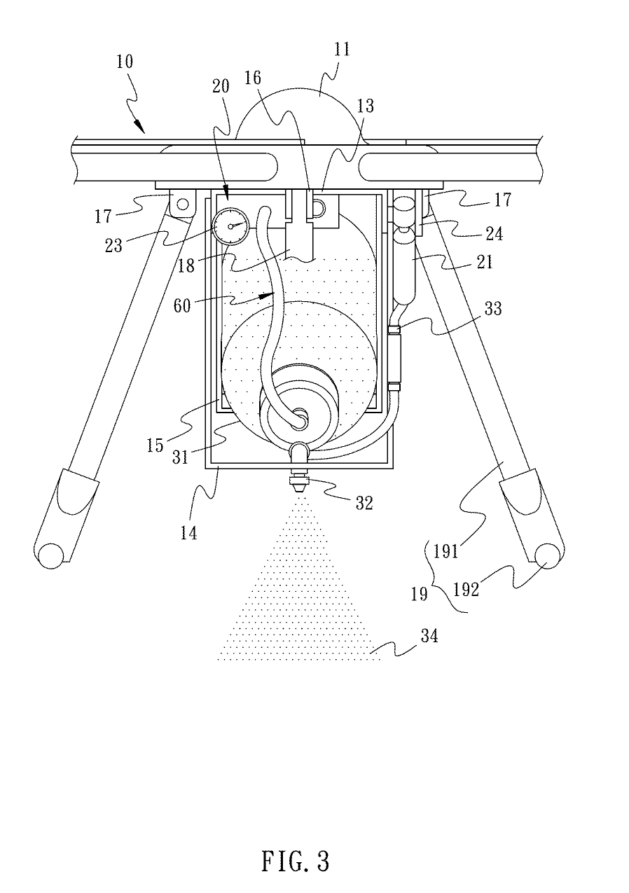

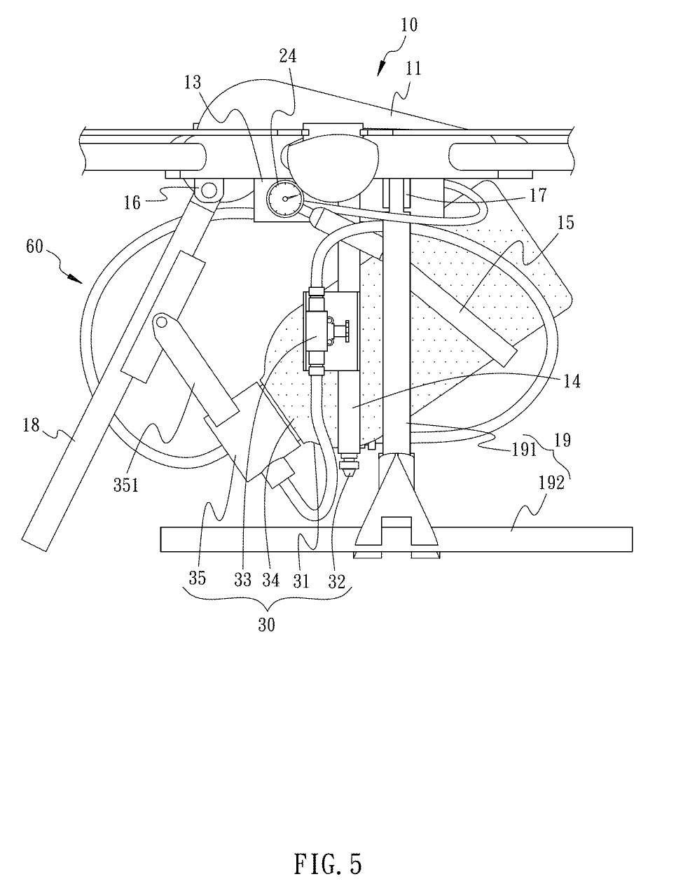

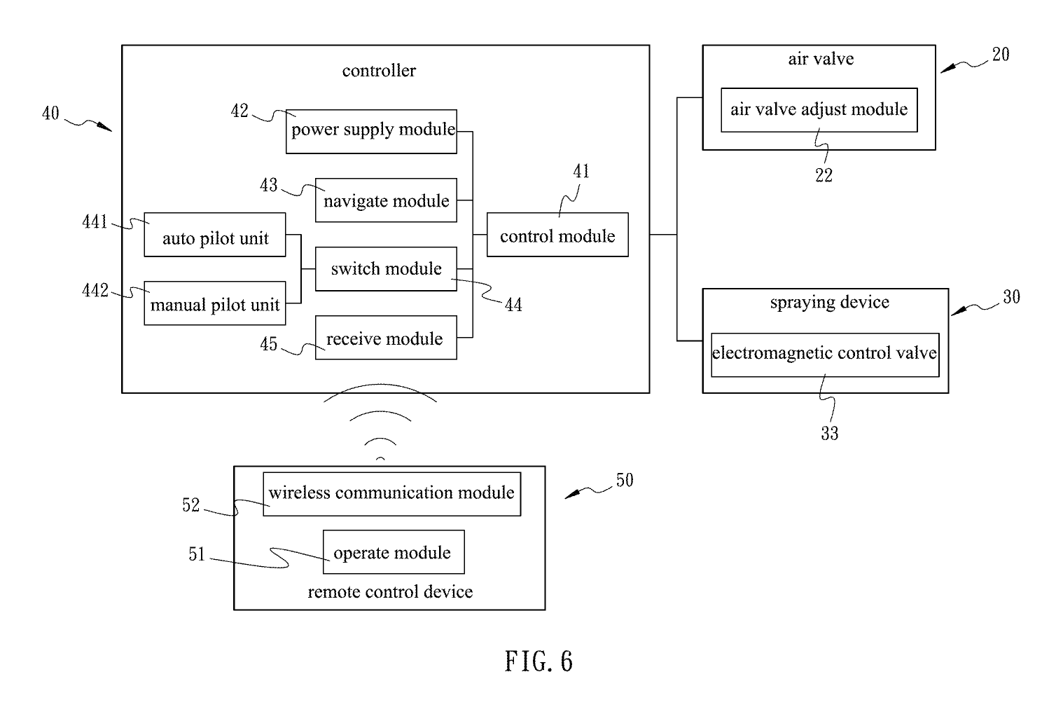

Referring to FIG. 1 to FIG. 7, an unmanned flying spray system is provided, comprising a flying device 10, an air valve 20, and a spraying device 30.

The flying device 10 is provided with a main body 11. The main body 11 is provided with a plurality of rotary wings 12. In an embodiment of the present invention, the rotary wings 12 are provided in a form of a six-axis rotary wing, such that the rotary wings 12 are equidistantly disposed around the main body 11. The main body 11 has the bottom portion thereof provided with a connect rack 13, a nozzle frame 14, and a fix frame 15. The nozzle frame 14 and the fix frame 15 are formed in a U shape, and fastened to the two sides of the connect rack 13, respectively. The open end of the nozzle frame 14 is fastened to an outer side at the two sides of the connect rack 13, and the open end of the fix frame 15 is fastened to an inner side at the two sides of the connect rack 13. The nozzle frame 14 is vertically disposed on the main body 11. The fix frame 15 is inclined toward the rear side of the main body 11 away from the nozzle frame 14.

Also, the main body 11 has the bottom portion thereof provided with a first pivot connect portion 16 and two second pivot connect portions 17. The first pivot connect portion 16 is fixed in the connect rack 13 for pivotally combining a fix foot 18. The fix foot 18 is pivotally disposed to be inclined toward the front side of the main body 11 away from the nozzle frame 14, such that the fix foot 18 is allowed to pivotally sway against the connect rack 13. The two second pivot connect portions 17 pivotally combine two landing stands 19. The landing stands 19 are pivotally disposed to be inclined toward the left and right sides of the main body 11 away from the fix foot 18, such that the landing stands 19 are allowed to pivotally sway against the main body 11. Also, each landing stand 19 is provided with a support rod 191 and a stabilizer bar 192 disposed in vertical to the support rod 191, thereby allowing the flying device 10 to fly in balance and stably land.

The air valve 20 is disposed at the bottom portion of the flying device 10. In an embodiment of the present invention, the air valve 20 is fixed to the inner side of the connect rack 13. The air valve 20 is connected with a gas cylinder 21. The gas cylinder 21 is applied for outputting a gas power, wherein the gas in the gas cylinder 21 is selected from any natural gas. In an embodiment of the present invention, the gas in the gas cylinder 21 is CO₂ with an 8 PA pressure. The gas cylinder 21 is fixedly disposed inclined on a lateral side of the connect rack 13. The inclining direction of the gas cylinder 21 is identical to the inclining direction of the fix frame 15. The air valve 20 includes an air valve adjust module 22 for adjusting a strength of the gas power output by the air valve 20.

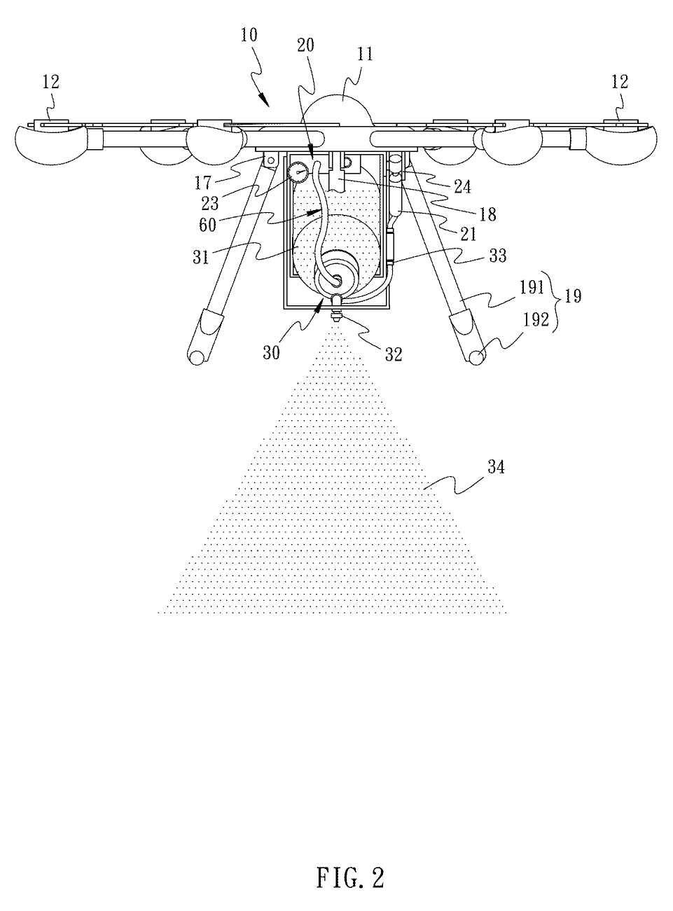

Further, referring to FIG. 2 to FIG. 5, the air valve 20 is provided with a first barometer 23, and the gas cylinder 21 is provided with a second barometer 24. The first barometer 23 is disposed to be connected with the air valve 20 for sensing the pressure value of the air valve 20, so as to determine the strength of the gas power output, thereby determining if the gas cylinder 21 has run out of gas.

The spraying device 30 is disposed at the bottom portion of the flying device 10. The spraying device 30 includes a pesticide container 31, a nozzle 32, and an electromagnetic control valve 33. In an embodiment of the present invention, the pesticide container 31 is applied for containing a pesticide 34. The nozzle 32 is disposed at the bottom portion of the nozzle frame 14. The pressure of the nozzle 32 is 2 PA.

The electromagnetic control valve 33 is applied for controlling the pesticide 34 in the pesticide container 31 to be delivered to the nozzle 32.

Also, the pesticide container 31 has one end thereof provided with a diverting member 35. The diverting member 35 is formed in a T-junction connector. The diverting member 35 has one lateral side thereof provided with a combine potion 351. In an embodiment of the present invention, the combine portion 351 is provided with a recess, so as to be removably fixed on the fix foot 18 and inclined, whereby the top end of the pesticide container 31 is inclined downward against the fix foot 18. The body of the pesticide container 31 is fixed on the bottom portions of the nozzle frame 14 and the fix frame 15. The diverting member 35 is connected with the air valve 20, the pesticide container 31, and the nozzle 32 through a plurality of pipes 60, respectively. The electromagnetic control valve 33 is disposed between the nozzle 32 and the diverting member 35.

A controller 40 is disposed inside the main body 11 of the flying device 10. The controller 40 includes a control module 41, a power supply module 42 electrically connected with the control module 41, a navigate module 43, a switch module 44, and a receive module 45. The power supply module 42 is electrically connected with the rotary wings 12 for supplying the flying power to the flying device 10. The navigate module 43 is applied for acquiring a geographic position information. The switch module 44 includes an auto pilot unit 441 and a manual pilot unit 442.

When the user switches the present invention to activate to the auto pilot unit 441, the auto pilot unit 441 sets an automatic flying route, a target spraying area, and a height of flying based on the geographic position information, such that the flying device 10 automatically flies to the target spraying area according to the automatic flying route and the height of flying and sprays the pesticide 34 at the target spraying area. When the user switches the present invention to activate the manual pilot unit 442, the manual pilot unit 442 is manually controlled to drive the flying device 10 to fly to the target spraying area.

In addition, the control module 41 of the controller 40 is electrically connected with the air valve adjust module 22 of the air valve 20 and the electromagnetic control valve 33 of the spraying device 30 for controlling the power strength of the air valve 20 and the ON and OFF status of the electromagnetic control valve 33.

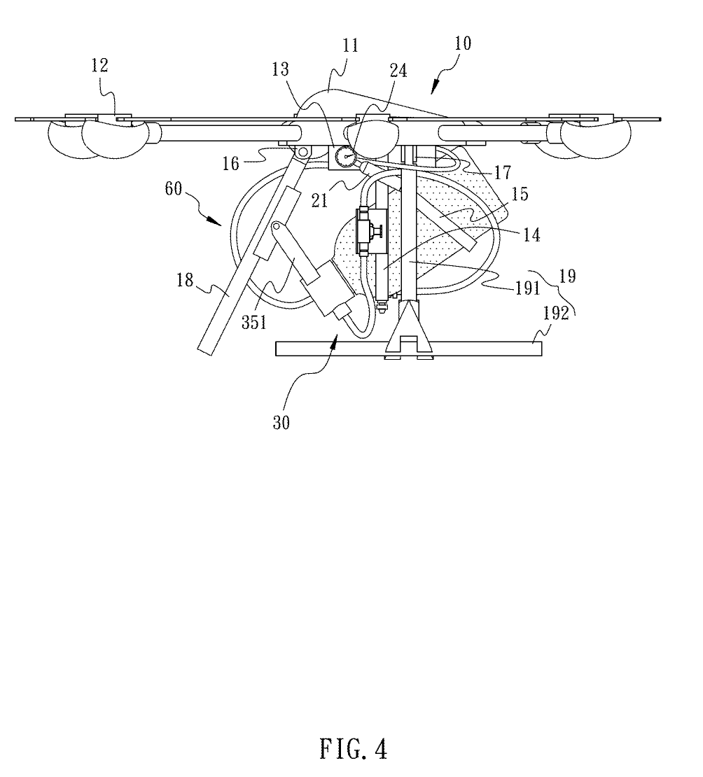

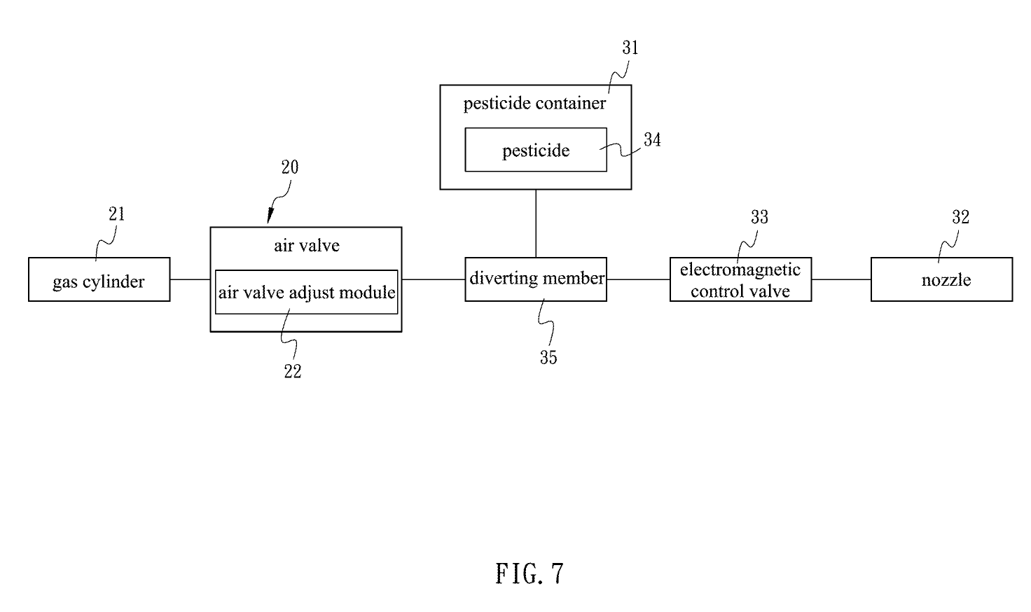

Referring to FIG. 4 and FIG. 7, when the electromagnetic control valve 33 is practically turned ON, because of the pressure of the gas cylinder 21 is larger than the pressure of the nozzle 32, the gas power of the air valve 20 simultaneously delivers the pesticide 34 in the pesticide container 31 to the diverting member 35. Finally, the pesticide 34 is sprayed through the nozzle 32. With such gas powered spraying method, the overall weight of the flying device 10 is greatly reduced, so as to improve the flying stability of the flying device 10.

A remote control device 50 includes an operate module 51 and a wireless communication module 52 electrically connected with the operate module 51. The wireless communication module 52 is connected with the receive module 45 of the flying device 10 through a wireless internet or Bluetooth structure. The user operates the operate module 51 to remotely control the flying device 10 to fly, and also control the electromagnetic control valve 33 of the spraying device 30 to be turned ON or OFF.

To sum up, the unmanned flying spray system of the present invention applies the gas power of the gas cylinder 21 to spray the pesticide 34. The gas cylinder 21 is provided with a small volume and a light weight, so as to greatly reduce the overall weight of the flying device 10 and improve the flying stability of the flying device 10, such that the flying device 10 is easily control to conduct the flying operation, facilitating an evenly sprayed effect of the pesticide 34. Also, the containing capacity of the pesticide 34 is increased, so as to lower the pesticide refilling demands.

Furthermore, when the user wishes to spraying the pesticide 34 at a relatively large area, the user is allowed to operate the unmanned flying spray system to switch to the auto pilot unit 441 and the manual pilot unit 442. Therefore, the user is prevented from directly contacting the pesticide 34 and easily conduct the pesticide 34 spraying operation, improving the convenience of usage of the present invention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An unmanned flying spray system, comprises:
a flying device provided with a controller, the controller including a control module and a power supply module electrically connected with the control module, the power supply module providing a flying power to the flying device;
an air valve disposed on the flying device, the air valve connected with a gas cylinder, the gas cylinder outputting a gas power; and
a spraying device provided with a pesticide container, an electromagnetic control valve electrically connected with the control module, and a nozzle, the pesticide container provided with a diverting member, the diverting member connected with the air valve, the pesticide container, and the nozzle, wherein the electromagnetic control valve is disposed between the diverting member and the nozzle.

2. The unmanned flying spray system of claim 1, wherein the flying device comprises a nozzle frame and a fix frame, the nozzle disposed at a bottom portion of the nozzle frame, the nozzle frame disposed in vertically disposed on the flying device, the fix frame disposed on the flying device and arranged in vertical to the nozzle frame.

3. The unmanned flying spray system of claim 2, wherein the flying device is provided with a connect rack, such that the nozzle frame is fastened to two short outer sides of the connect rack, and the fix frame is fastened to two short inner sides of the connect rack.

4. The unmanned flying spray system of claim 2, wherein a top portion of the gas cylinder is fixedly disposed on a lateral side of the connect rack and arranged inclined; an inclining direction of the gas cylinder is identical to an inclining direction of the fix frame.

5. The unmanned flying spray system of claim 1, wherein the air valve includes an air valve adjust module electrically connected with the control module for controlling the gas power output.

6. The unmanned flying spray system of claim 1, wherein the air valve is provided with a first barometer, and the gas cylinder is provided with a second barometer.

7. The unmanned flying spray system of claim 1, wherein the flying device is provided with a first pivot connect portion for pivotally combining a fix foot; the diverting member is provided with a combine portion removably fixed on the fix foot and arranged inclined.

8. The unmanned flying spray system of claim 1, wherein the flying device is provided with two second pivot connect portions for pivotally combining two landing stands; each of the landing stand includes a support rod and a stabilizer bar arranged in vertical to the support rod.

9. The unmanned flying spray system of claim 1, further comprising a remote control device, the remote control device including an operate module and a wireless communication module electrically connected with the operate module; the flying device further includes a navigate module and a receive module that are electrically connected with the control module, the navigate module acquiring a geographic position information, the wireless communication module remotely connected with the receive module, the control module controlling a flying route of the flying device and controlling the electromagnetic control valve to be turned ON and OFF.

10. The unmanned flying spray system of claim 9, wherein the flying device further comprises a switch module electrically connected with the control module, the switch module including an auto pilot unit and a manual pilot unit; the auto pilot unit sets an auto flying route, a target spraying area, and a height of flying based on the geographic position information, the manual pilot unit operates in coordination with the remote control device to control the flying device.
